(19) United States
(12) Patent Application Publication
(10) Pub. No.: US 2010/0007734 A1
(43) Pub. Date: Jan. 14, 2010

(54) VEHICULAR IMAGE PROCESSING DEVICE, AND VEHICULAR IMAGE PROCESSING PROGRAM

(75) Inventors: Osamu Yamazaki, Tsurugashima-shi (JP); Hiroto Inoue, Tsurugashima-shi (JP); Naohiko Ichihara, Tsurugashima-shi (JP); Shinichi Sugie, Tsurugashima-shi (JP); Junya Ochi, Kawagoe-shi (JP)

Correspondence Address: YOUNG & THOMPSON, 209 Madison Street, Suite 500, Alexandria, VA, 22314, US

(73) Assignee: PIONEER CORPORATION, Tokyo (JP)

(21) Appl. No.: 12/523,246

(22) PCT Filed: Jan. 16, 2007
(86) PCT No.: PCT/JP2007/050499

§ 371 Date: Sep. 8, 2009

(51) Int. Cl. H04N 7/18

(52) U.S. Cl. 348/148

(57) ABSTRACT

Both converted image data obtained upon conversion of rearward image data taken by a camera by an imaging converting unit, and auxiliary display line data generated by an OSD creating unit are outputted as display image data on a display device. As a result, converted rearward images and auxiliary display lines are displayed superimposed on the display element. An operator displays the rearward images during conversion while utilizing the auxiliary display lines on the display screen to perform rotation processing, parallel movement processing, and skew processing until the image appears in a desired position.

### CROSS REFERENCE TO RELATED APPLICATION

This is an application PCT/JP2007/50499, filed Jan. 16, 2007, which was not published under PCT article 21(2) in English.

### BACKGROUND OF THE INVENTION

1. Field of the Invention

The present invention relates to a vehicular image processing device and vehicular image processing program for performing predetermined image processing on an image taken by imaging means provided to a vehicle.

2. Description of the Related Art

Vehicles (hereinafter “automobiles” as an illustrative example) of recent years are provided with a system comprising a mounted imaging means (hereinafter “camera” as an illustrated example) for checking the periphery view thereof, and a mounted function (hereinafter “rearward display function”) for displaying a rearward image taken by the camera on display means provided inside the vehicle when the driver is backing up, for example. Such a rearward display function displays on the display means inside the vehicle a rearward image taken by a camera disposed outside the vehicle, at the rear (refer to JP, A, 2004-32464, for example). In this prior art is disclosed a vehicular image processing device (vehicle periphery monitoring device) configured to switch and display a rearward image taken by a camera using various descending vertical angles (0°, 10°, 20°, 30°, etc.).

### SUMMARY OF THE INVENTION

### Problem to be Solved by the Invention

In a vehicle where a rearward display function is mounted as described above, the camera mounted at the vehicle rear is sometimes disposed in a position shifted away from the substantial center of the vehicle width direction due to vehicle design restrictions and device layout restrictions. In such a case, the rearward image taken by the camera may be displayed on the display means without bilateral symmetry, resulting in a sense of discomfort in the driver.

To tackle such an inconvenience, for example, it is necessary to convert the rearward image taken by the camera to an image viewed from a viewpoint of the substantial center of the vehicle width direction, and display this converted image so as to alleviate the sense of discomfort of the driver. The degree and details of the conversion required at this time (unlike, for example, a perfect camera having a predetermined installation location) may differ, depending on the individual vehicle. In such a case, each operator (driver) must make adjustments while monitoring the converted image on the display means and form the desired image. Nevertheless, since a plurality of parameters are involved in image formation, it is extremely difficult for the operator, who is a technical amateur, to make adjustments as needed while displaying the converted image on the display means so as to form a favorable image (from an optimum virtual viewpoint for backing up the vehicle, for example).

The above-described issue is given as one example of a problem that is to be solved by the present invention.

### Means of Solving the Problem

To achieve the object, the invention of Claim 1 comprising: an image acquiring unit configured to acquire peripheral image data based on a peripheral image of a vehicle using an imaging unit configured to take images or the periphery of the vehicle; an image converting unit configured to perform conversion processing on the peripheral image data acquired by the image acquiring unit and generate converted image data; an instruction signal inputting unit configured to input an instruction signal for providing instructions regarding a conversion processing mode to be achieved by the image converting unit; an auxiliary display line generating unit configured to generate auxiliary display line data for an auxiliary display on a display unit for providing instructions for the conversion processing mode; and an image outputting unit configured to output display image data generated based on the converted image data and the auxiliary display line data, wherein: the auxiliary display line generating unit generates the auxiliary display line data so as to display a scaled horizontal line after to display a plurality of mutually parallel horizontal lines, as the auxiliary display in accordance with the conversion processing mode instructed by the instruction signal, and the image converting unit performs as the conversion processing rotation processing on the peripheral image data so as to generate the converted image data when the auxiliary display line generating unit generates the auxiliary display line data so as to display as the auxiliary display a plurality of mutually parallel horizontal lines, and subsequently the image converting unit performs as the conversion processing parallel movement processing on the peripheral image data so as to generate the converted image data when the auxiliary display line generating unit generates the auxiliary display line data so as to display as the auxiliary display the scaled horizontal line; and further subsequently the image converting unit performs as the conversion processing skew processing on the peripheral image data so as to generate the converted image data when the auxiliary display line generating unit generates the auxiliary display line data so as to display as the auxiliary display the scaled horizontal line.

To achieve the object the invention of Claim 5 comprising the steps of: a step for acquiring peripheral image data based on a captured peripheral image of a vehicle; a step for inputting an instruction signal for providing instructions regarding a conversion processing mode of the conversion processing to the peripheral image data acquired; a step for performing rotation processing on the peripheral image data acquired as conversion processing and generating converted image data as well as generating auxiliary display line data so as to display a plurality of mutually parallel horizontal lines as the auxiliary display in accordance with the conversion processing mode instructed by the instruction signal; a step for performing parallel movement processing on the peripheral image data acquired as conversion processing and generating converted image data as well as generating auxiliary display line data so as to display a scaled horizontal lines as the auxiliary display in accordance with the conversion processing mode instructed by the instruction signal, after the step for performing rotation processing; a step for performing skew processing on the peripheral image data acquired as conversion processing and generating converted image data as well as generating auxiliary display line data so as to display the scaled horizontal lines as the auxiliary display in accordance with the conversion processing mode instructed by the instruction signal, after the step for performing parallel processing; and a step for outputting display image data generated based on the converted image data and the auxiliary display line data.

### BRIEF DESCRIPTION OF THE DRAWINGS

FIG. 1 is a conceptual view illustrating a configuration example of a vehicle where a vehicular image processing device of an embodiment of the present invention is mounted.

FIG. 2 is an image view illustrating the mode in which the camera takes an image of the area behind the vehicle.

FIG. 3 is a block view illustrating a configuration example of the image processing device shown in FIG. 1.

FIG. 4 is a conceptual outer appearance view illustrating the details of the operation switch shown in FIG. 1.

FIG. 5 is an example of a rear view from the direction of the arrow A in FIG. 1 viewed from behind the vehicle.

FIG. 6 is a view illustrating an example of a screen displayed on the display device based on display image data outputted from the output image creating unit without image conversion.

FIG. 7 is another example of a rear view from the direction of the arrow A in FIG. 1 viewed from behind the vehicle.

FIG. 8 is a view illustrating an example of a screen displayed on the display device based on display image data outputted from the output image creating unit (without image conversion yet performed).

FIG. 9 is a view illustrating an example of a screen displayed on the display device based on display image data outputted from the output image creating unit when rotation processing is performed.

FIG. 10 is a view illustrating an example of a screen displayed on the display device based on display image data outputted from the output image creating unit when parallel movement processing is performed after rotation processing completion.

FIG. 11 is a view illustrating an example of a screen displayed on the display device based on display image data outputted from the output image creating unit when skew processing is performed after rotation processing and parallel movement processing completion.

FIG. 12 is a view illustrating an example of a display screen of the display device after rotation, parallel movement, and skew processing are completed.

FIG. 13 is a view illustrating an example of a screen displayed on the display device based on display image data outputted from the output image creating unit when viewpoint conversion processing is performed after rotation, parallel movement, and skew processing are completed.

FIG. 14 is a view illustrating an example of a display screen of the display device after rotation, parallel movement, skew, and viewpoint conversion processing are completed.

FIG. 15 is a view illustrating an example of a display screen of the display device after rotation, parallel movement, skew, and viewpoint conversion processing are completed.

### DETAILED DESCRIPTION OF THE PREFERRED EMBODIMENTS

The following describes an embodiment of the present invention with reference to accompanying drawings.

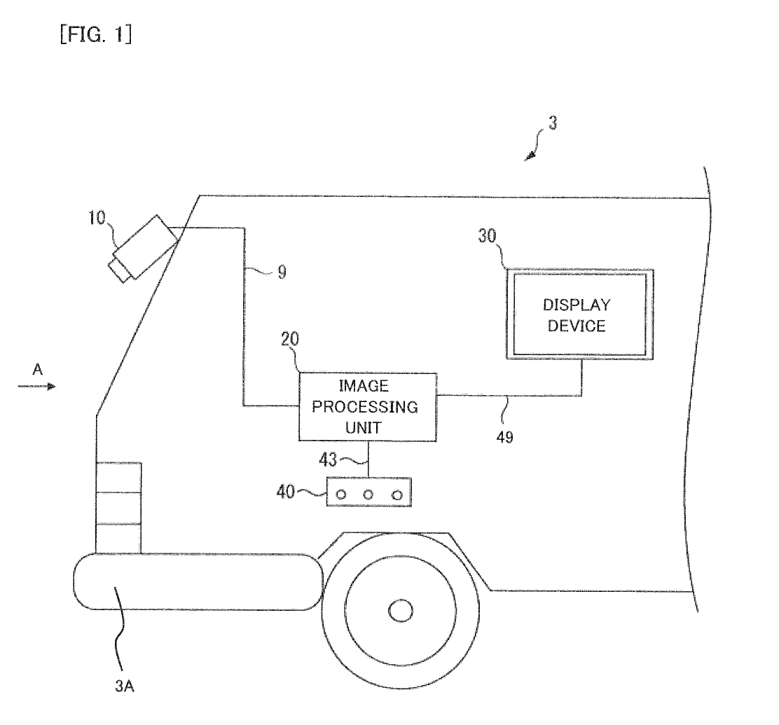

FIG. 1 is a conceptual view showing a configuration example of a vehicle 3 where a vehicular image processing device (hereinafter simply referred to as “image processing device”) 20 of the present embodiment is mounted.

The vehicle 3 is an automobile comprising a bumper 3A, for example, and is capable of moving forward and backward and turning left and right according to an operation performed by the driver. On this vehicle 3 are mounted a camera 10 (imaging unit), the image processing device 20, an operation switch 40 (operating unit), and a display device 30 (display means).

The camera 10 is a so-called digital camera that employs a charge-coupled device (CCD), for example. This camera 10 takes images of the periphery of the vehicle 3 (in this example, a camera that takes images rearward, sideways, and frontward is acceptable), and has a function that obtains peripheral image data (in this example, rearward image data) 9 based on the image (in this example, rearward image) of the peripheral view of this vehicle 3. The camera 10 takes images using a wide-angle lens, for example, in order to capture the view behind the vehicle 3 at a wider angle. The image taken by this camera 10 is sometimes somewhat distorted due to the effect of using a wide-angle lens.

The image processing device 20 generates converted image data 27 by performing predetermined conversion processing on the rearward image data 9 and, in addition, auxiliary line data 48 (described in detail later), and outputs display image data 49 for displaying the rearward image data 27 and the auxiliary line data 48 superimposed on the display device 30. With this arrangement, the image processing device 20 has a function that adjusts a rearward image 15 of the vehicle 3 to a desired image in accordance with an operation signal (instruction signal) 43 of the operation switch 40.

The display device 30 has a function that displays the rearward image based on the converted image data 27 received from the image processing device 20. This display device 30 is a display such as a liquid crystal display device provided inside the vehicle 3, for example. This display device 30 is capable of serving as a display device of a navigation system that provides guidance with regards to a route that should be taken, and as a display device for a television receiver, for example.

The operation switch 40 generates and outputs to the image processing device 20 the aforementioned instruction signal 43 configured to provide instructions regarding the conversion processing mode of the image to be achieved by the image processing device 20 by operation thereof. With this arrangement, the operation switch 40 has a junction that provides instructions regarding the conversion processing mode of the rearward image data 9 of the image processing device 20. While an operation switch provided to the image processing device 20 is used as this operation switch 40 in this embodiment, a touch panel, etc., provided to the liquid crystal display screen or the display device 30 may also be used.

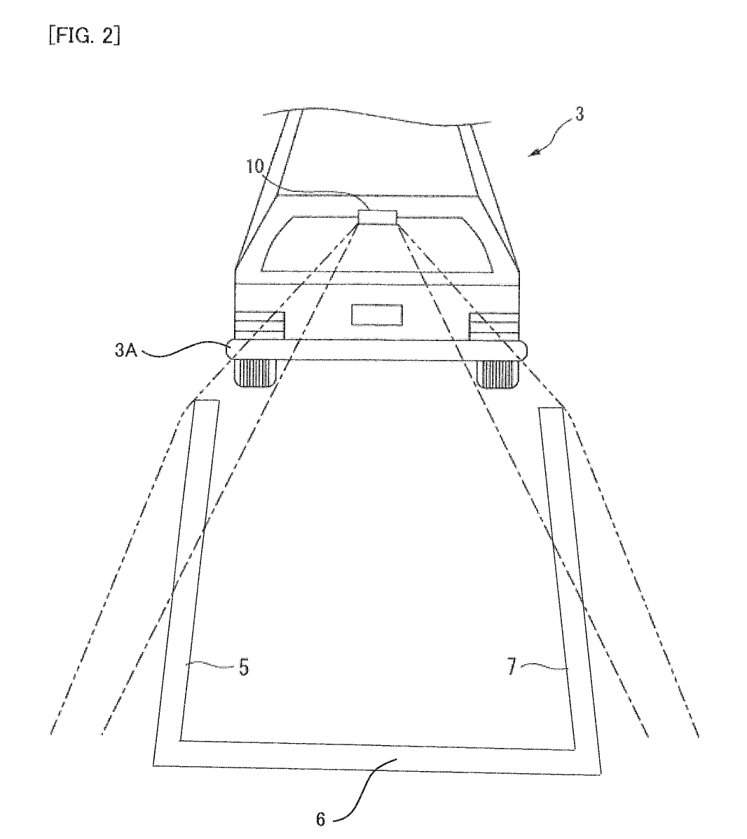

FIG. 2 is an image view illustrating the mode in which the camera 10 takes an image of the area behind the vehicle 3. The dashed-two dotted line in the figure indicates the range of the road surface of the parking lot that can be captured by the camera 10, and the dashed-one dotted line indicates the range of the space above the road surface of the parking lot that can be captured by the camera 10.

In this embodiment, the driver of the vehicle 3 is attempting to back up so as to park in a parking lot, for example. On this parking lot exist parking space lines (comprising three border lines 5, 6, and 7, including the left border line 7, the right border line 5, and the back border line 6, along the backup direction of the vehicle, for example) that serve as a guide for a parking place for the vehicle 3. The left and right border lines 5 and 7 are drawn on the road surface of the parking lot so as to be mutually parallel at an interval somewhat wider than the width of the vehicle 3.

The camera 10 in this example is mounted on the upper rear area of the vehicle 3 as described above, and is capable of taking a rear view image of the vehicle 3 within the capturable range. The capturable range of this camera 10 includes the above-described border lines 5, 6, and 7.

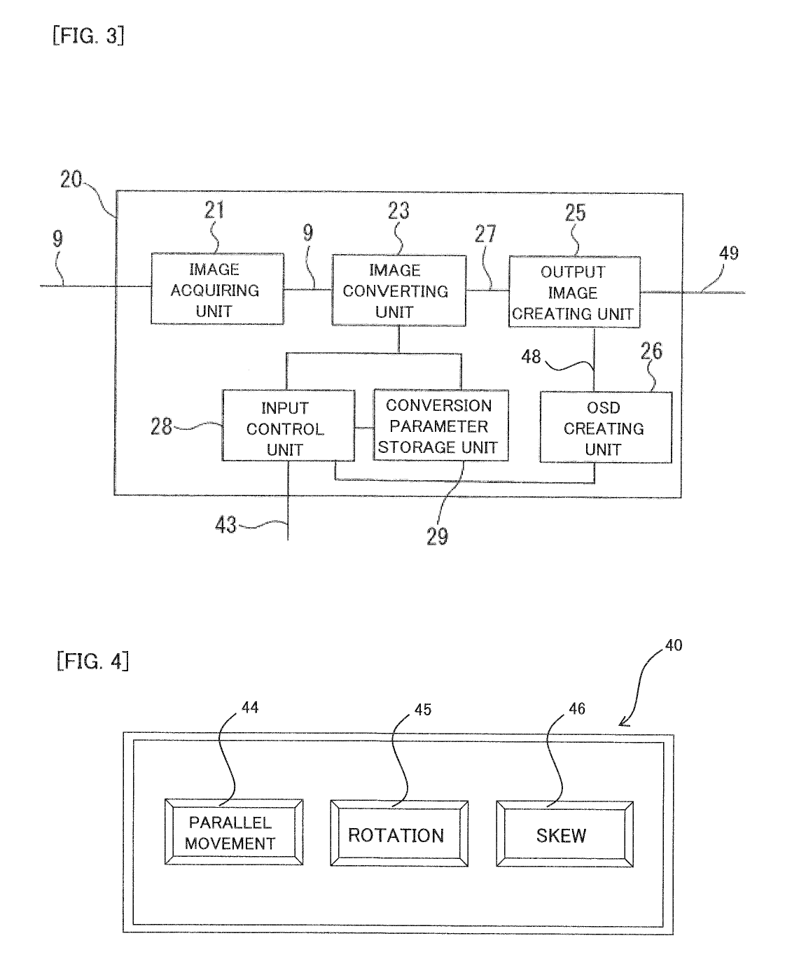

FIG. 3 is a block view illustrating a configuration example of the image processing device 20 shown in FIG. 1. The image processing device 20, although not shown in detail, comprises, for example, a computer having an operation unit comprising a central processing unit (CPU), a memory comprising ROM and RAM, and the like. Then, a predetermined vehicular image processing program is stored in the ROM, and control processing for performing image processing such as described later is executed by this program.

Such the image processing device 20 functionally comprises, as shown in FIG. 3, an image acquiring unit 21 (image acquiring unit), an image converting unit 23, an output image creating unit 25 (image outputting unit), an input control unit 28 (instruction signal inputting unit), a conversion parameter storage unit 29, and an OSD creating unit 26 (auxiliary display line generating unit).

The rearward image data 9 based on the rearward image of the vehicle 3 taken by the camera 10 are inputted into the image processing device 20. The inputted rearward image data 9 are acquired by the image acquiring unit 21. On the other hand, the instruction signal 43 generated by operation of the operation switch 40 and configured to provide instructions regarding the conversion processing mode of the image to be achieved by the image processing unit 20 is inputted from the operation switch 40 into the image processing device 20. The inputted instruction signal 43 is inputted into the input control unit 28. This instruction signal 43 provides instructions regarding the conversion processing mode of the rearward image data to be achieved by the image converting unit 23 by specifying the conversion parameters stored in the conversion parameter storage unit 29. That is, the image converting unit 23 reads the conversion parameters stored in the conversion parameter storage unit 29 based on the instruction signal 43 inputted by the input control unit 28, and performs conversion processing on the rearward image data acquired by the image acquiring unit 21 using the read conversion parameters so as to generate the converted image data 27.

The conversion parameter storage unit 29 stores the conversion parameters for performing conversion processing (hereinafter “rotation processing”) on the rearward image data 9 so as to rotate the rearward image, conversion parameters for performing conversion processing (hereinafter “skew processing”) on the rearward image data 9 so as to change the gradient of the rearward image and form a parallelogram shape, and conversion parameters for performing conversion processing (hereinafter “parallel movement processing”) on the rearward image data 9 so as to move the rearward image parallel in the horizontal direction.

The rotation processing is performed based on the equations (1) and (2) below, given an adjustable parameter θr (with a size thereof that can be increased or decreased by the instruction signal 43) and a vertical x-axis direction and a horizontal y-axis direction of the display screen of the display device 30 (refer to FIG. 6 described later). Note that xn and yn in the equations indicate the coordinates after image conversion processing, and xo and yo indicate the coordinates before image conversion processing (the same holds true for the skew processing and parallel movement processing described later).

Equation 1:

xₙ=xₒ×cos θᵣ+yₒ×sin θᵣ (1)

Equation 2:

yₙ=yₒ×cos θᵣ−xₒ×sin θᵣ (2)

The skew processing is performed based on equations (3) and (4) shown below, given an adjustable parameter Oh (with a size thereof that can be increased or decreased by the instruction signal 43). As shown in these equations, in this example conversion is performed in the x-axis direction only in order to adjust the shift in the horizontal direction.

Equation 3:

xₙ=xₒ+yₒ×tan θₕ (3)

Equation 4:

yₙ=yₒ (4)

The parallel movement processing is performed based on equations (5) and (6) shown below, given an adjustable parameter tx (with a size thereof can be increased or decreased by the instruction signal 43). As shown in these equations, in this example conversion is performed in the x-axis direction only in order to adjust the shift in the horizontal direction.

Equation 5:

xₙ=xₒ+tₓ (5)

Equation 6:

yₙ=yₒ (6)

The OSD creating unit 26 generates auxiliary display line data respectively corresponding to the conversion processing modes of the rearward image data achieved by the image converting unit 23. This OSD creating unit 26, in this example, comprises rotation auxiliary display line data, skew auxiliary display line data, and parallel movement auxiliary display line data that respectively correspond to the rotation processing, skew processing, and parallel movement processing described above. Then, the OSD creating unit 26 inputs from the input control unit 28 the control signal corresponding to the instruction signal 43 inputted by the input control unit 28, creates auxiliary line data 48 corresponding to that signal (rotation auxiliary display line data, skew auxiliary display line data, or parallel movement auxiliary display line data corresponding to rotation processing, skew processing, or parallel movement processing), and outputs the created auxiliary line data 48 to the output image creating unit 25.

The output image creating unit 25 creates and outputs to the display device 30 the display image data 49 for displaying the converted image and auxiliary line data superimposed using the converted image data 27 and the auxiliary line data 48.

FIG. 4 is a conceptual outer appearance view illustrating the details of the operation switch 40 shown in FIG. 1. The operation switch 40 comprises a parallel movement button 44, a rotation button 45, and a skew button 46 respectively operable via pressing by the operator.

When the parallel movement button 44 is pressed, the corresponding parallel movement instruction signal 43 is inputted to the input control unit 28. As a result, parallel movement processing is performed on the rearward image data by the image converting unit 23 using the conversion parameters for parallel movement processing read from the conversion parameter storage unit 29 as described above, thereby converting the data to the converted image data 27 after processing. Further, the OSD creating unit 26 creates the corresponding auxiliary line data (parallel movement auxiliary display line data) 48.

Similarly, when the rotation button 45 of the operation switch 40 is pressed, the corresponding rotation instruction signal 43 is inputted to the input control unit 28. As a result, rotation processing is performed on the rearward image data by the image converting unit 23 using the conversion parameters for rotation processing read from the conversion parameter storage unit 29, thereby converting the data to the converted image data 27 after processing. Further, the OSD creating unit 26 creates the corresponding auxiliary line data (rotation auxiliary display line data) 48.

Similarly when the skew button 46 of the operation switch 40 is pressed, the corresponding skew instruction signal 43 is inputted to the input control unit 28. As a result, skew processing is performed on the rearward image data by the image converting unit 23 using the conversion parameters for skew processing read from the conversion parameter storage unit 29, thereby converting the data to the converted image data 27 after processing. Further, the OSD creating unit 26 creates the corresponding auxiliary line data (skew auxiliary display line data) 48.

Next, a specific example of the display modes of the display device 30 expressed by the image conversion processing described above will be described in due order.

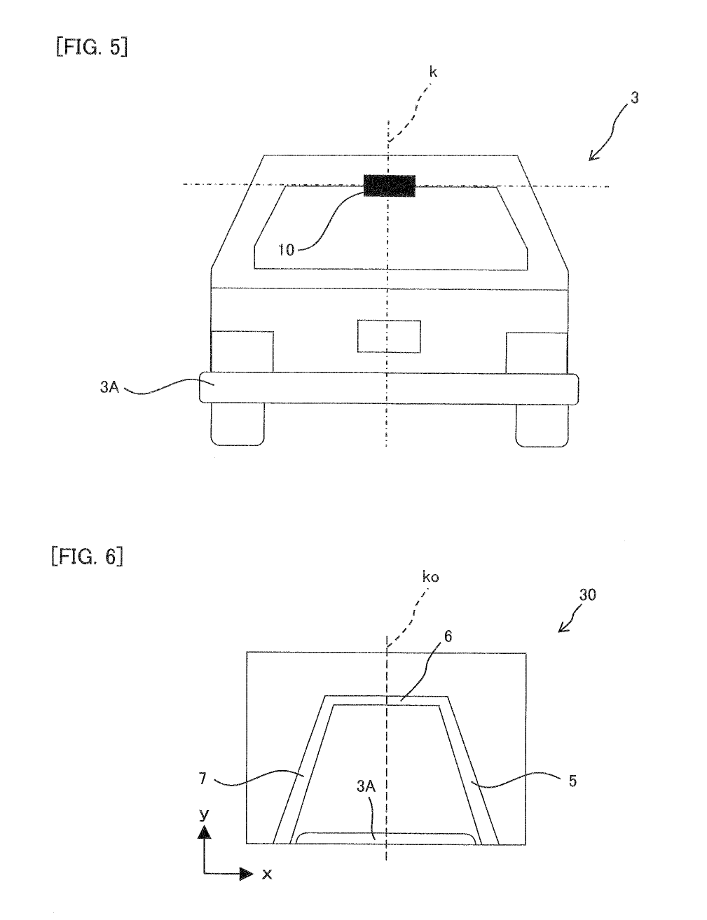

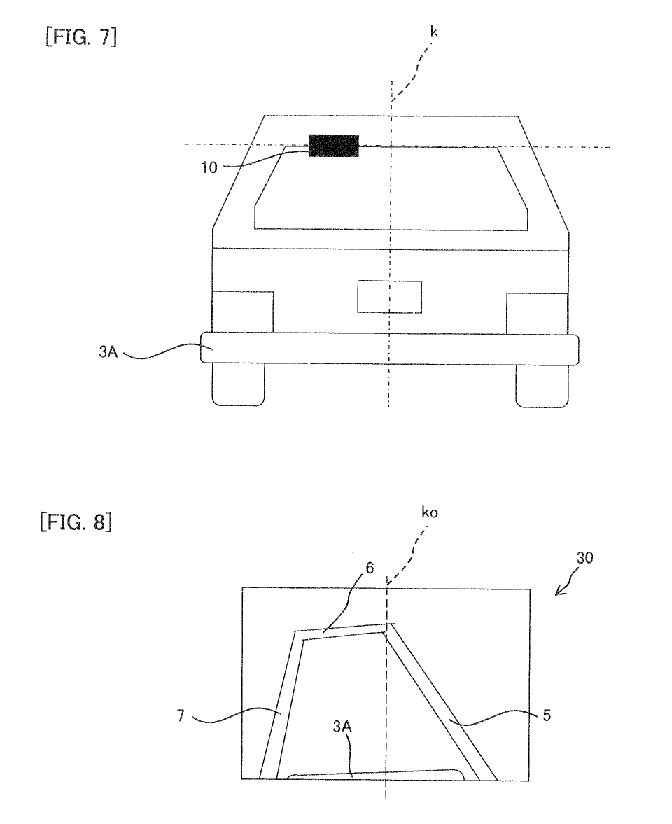

FIG. 5 is an example of a rear view from the direction of the arrow A in FIG. 1 viewed from behind the vehicle 3. In this example of FIG. 5, the camera 10 is installed horizontally on the centerline k (vertical line) of the width direction of the vehicle 3. In this case, (unlike the case of FIG. 7 described later), the aforementioned image conversion processing (parallel movement, rotation, skew, etc.) of the image converting unit 23 does not normally need to be performed. FIG. 6 illustrates an example of a screen displayed at this time by the display device 30 based on the display image data 49 outputted from the output image creating unit 25 (without image conversion).

As shown in FIG. 6, in this case, the center point of the back border line 6 is positioned on the centerline (vertical line) ko of the width direction of the screen, and the left border line 7 and the right border line 5 are displayed symmetrical with respect to this centerline ko.

FIG. 7 is another example of a rear view from the direction of the arrow A in FIG. 1 viewed from behind the vehicle 3. In a case where the camera 10 is installed by the operator (user), the camera 10 is sometimes not installed on the centerline k of the width direction of the vehicle 3 as in FIG. 5 described above due to installation errors (or, in some cases, due to the design restrictions or device layout restrictions of the vehicle 3). FIG. 7 shows a case where the camera 10 is installed further left in the figure than the centerline k of the width direction.

FIG. 8 illustrates an example of a screen displayed by the display device 30 based on the display image data 49 outputted from the output image creating unit 25 (without image conversion) at this time.

As shown in FIG. 8, in this case the shape of the border lines 5, 6, and 7 changes to an overall asymmetrical shape. That is, the back border line 6 generally shifts in the horizontal direction (leftward in this example) of the screen, and the center point thereof shifts to the left of the centerline (vertical line) ko of the width direction of the screen. Accordingly, the shapes and positions of the left border line 7 and the right border line 5 also shift to the left (more so than in the case of FIG. 6), and these border lines 5 and 7 are displayed asymmetrically with respect to the centerline ko. In this case, the aforementioned image conversion processing (parallel shift, rotation, skew, etc.) of the image converting unit 23 needs to be performed (due to the poor visibility of the operator when the image is left as is) to convert the viewpoint to that of the case of FIG. 5 and FIG. 6 having a camera 10 on the centerline k of the width direction of the vehicle 3.

While various patterns may be considered for the image conversion processing for converting this viewpoint, performance in the order of rotation processing→parallel movement processing→skew processing, (or rotation processing→skew processing→parallel movement processing), for example, is preferred due to the following reasons. That is, as is clear from the aforementioned equations (3) and (4) and equations (5) and (6), the y coordinates of the skew and parallel movement processing do not change (only the x coordinates change). Conversely, as is clear from equations (1) and (2), both the x coordinates and y coordinates change in rotation processing. Thus, performing rotation processing first with the y coordinates of the rearward image fixed to desired positions, and then performing the parallel movement processing and/or skew processing so as to adjust the x coordinates of the rearward image to desired positions is easy for the operator to understand and execute. The following describes as an example a case where conversion is executed by the operator in the order of rotation processing→parallel movement processing→skew processing.

### (A) Rotation Processing

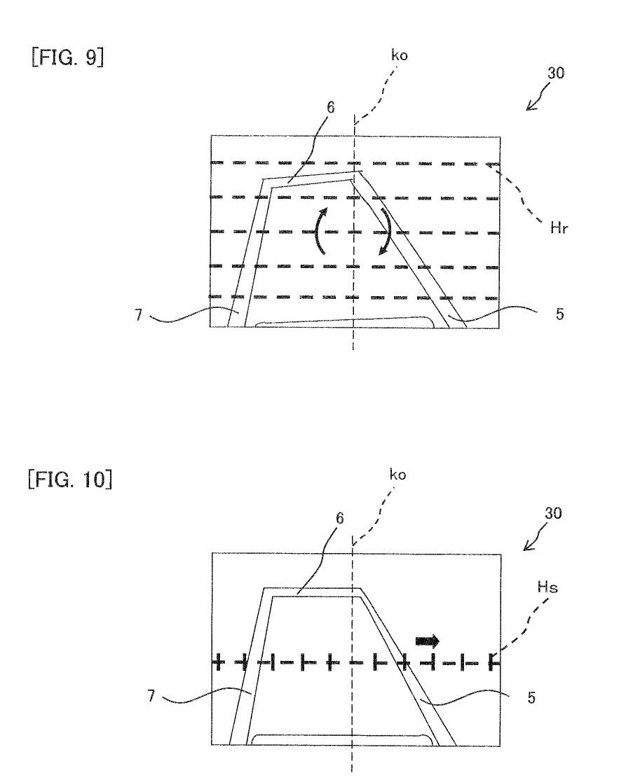

FIG. 9 shows an example of a screen displayed on the display device 30 based on the display image data 49 outputted from the output image creating unit 25 when the operator presses the rotation button 45 to perform rotation processing. In this example, when the operator presses the rotation button 45, the auxiliary line data (rotation auxiliary display line data) 48 from the aforementioned OSD creating unit 26 are outputted to the display device 30 via the output image creating unit 25. As a result, a plurality of mutually parallel horizontal lines (dashed lines in this example, but solid lines are acceptable as well) is displayed as rotation auxiliary display lines Hr as shown in the figure. Note that, rather than the rotation button 45, a button for displaying the rotation auxiliary display lines Hr (or a button for transitioning to rotation processing mode) may be separately provided. At this point in time, the above-described rotation auxiliary display lines Hr and the rearward image not yet subjected to rotation processing (same as that shown in FIG. 8; an image of the border lines 5, 6, and 7, and the bumper 3A) are both displayed on the screen of the display device 30. As a result, the operator can clearly visually recognize to what degree the rearward image should be rotated.

When the operator continues from the above state and presses the rotation button 45, θr of the above-described equation (1) and equation (2) of rotation processing increases (or decreases) by a predetermined value. This increase or decrease causes the rearward image on the display screen to slightly rotate by a predetermined rotation amount (angle) in a predetermined direction (clockwise on the display screen of the display device 30 in this example). By repeating this, the operator can perform his/her intended rotation processing operation on the rearward image.

The rotation auxiliary display lines Hr at this time are displayed based on a fixed positional relationship on the display screen of the display device 30, unlike the rearward image (the image of the border lines 5, 6, and 7, and the bumper 3A; hereinafter simply “rearward images 5, 6, and 7”) that slightly rotates as this rotation processing operation progresses. Thus, the relative positional relationship between the rotation auxiliary display lines Hr and the rearward images 5, 6, and 7 changes according to the slight rotation of the rearward image. As described above, the purpose of first performing this rotation processing is to fix the y coordinates of the rearward images 5, 6, and 7. Thus, specifically, the operator may simply repeatedly press the rotation button 45 until the back border line 6 (which naturally eliminates the sense of discomfort visually when eventually displayed in the horizontal direction) on the display screen of the display device 30 becomes substantially parallel with the rotation auxiliary display lines Hr (that is, substantially in the horizontal direction) on the display screen (refer to FIG. 10 described later). By performing the rotation processing operation using the rotation auxiliary display lines Hr as a guide, the operator can, in other words, determine the optimum rotation processing roll angle that should be provided to the rearward images 5, 6, and 7.

Note that, rather than repeatedly pressing the rotation button 45 to rotate the image to a desired angle as described above, a button for uniquely determining the rotation amount and rotation direction may be separately provided. Additionally, the form (color, shape, etc.) of a portion of the plurality of rotation auxiliary display lines Hr may be made to differ from that of the others. Also, in a case where the rotation processing has substantially ended (in a ease where a corresponding section among, the rearward images 5, 6, and 7, such as the rear border line 6, for example, is substantially parallel with the rotation auxiliary display lines Hr), the form is made to differ from the form up to that time. Further, in conjunction with completion of this processing, a notification indicating completion (a visual display or audio notification) may be provided.

### (B) Parallel Movement Processing

After the above rotation processing, parallel movement processing is performed (note that the order may be switched with the skew processing described later). FIG. 10 shows an example of a screen displayed on the display device 30 based on the display image data 49 outputted from the output image creating unit 25 when the operator presses the parallel movement button 44 of the operation switch 40 to perform parallel movement processing. In this example, when the operator presses the parallel movement button 44, the auxiliary line data (parallel movement auxiliary display line data) 48 from the aforementioned OSD creating unit 26 are outputted to the display device 30 via the output image creating unit 25. As a result, a scaled horizontal line as shown in the figure (a dashed line in this example, but a solid line is acceptable as well) is displayed as the horizontal movement auxiliary display line Hs. At this time, in this example, this horizontal movement auxiliary display line Hs is set and displayed at a y coordinate position where x coordinates do not change as a result of the skew processing described later (for example, at the position of the vertical center y=0 of the display screen). Note that, similar to the above, rather than the horizontal movement button 44, a button for displaying the horizontal movement auxiliary display line Hs (or a button for transitioning to horizontal movement mode) may be separately provided. At this point in time, the horizontal movement auxiliary display line Hs and the rearward images 5, 6, and 7 without the horizontal movement processing yet performed are displayed on the screen of the display device 30 (refer to FIG. 10). As a result, the operator can clearly visually recognize to what degree the rearward images 5, 6, and 7 should be moved horizontally.

When the operator continues from the above state and presses the horizontal movement button 44, tx of the above-described equation (5) of parallel movement processing increases (or decreases) by a predetermined value. This increase or decreases causes the rearward images 5, 6, and 7 on the display screen to slightly move horizontally by a predetermined shift amount (a predetermined number of dots, for example) in a predetermined direction (rightward on the display screen of the display device 30 in this example). By repeating this, the operator can perform his/her intended parallel movement processing operation on the rearward images 5, 6, and 7.

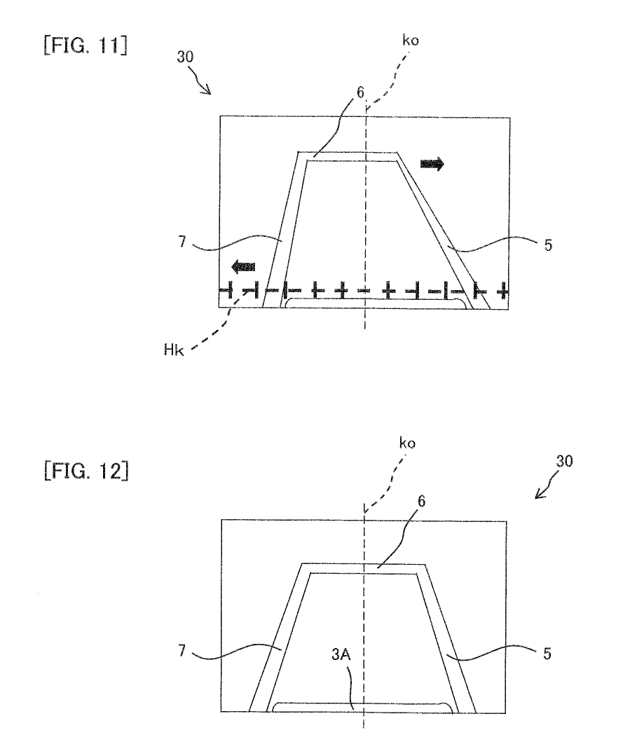

Similar to the above, at this time, the parallel movement auxiliary display line Hs is displayed based on a fixed positional relationship on the display screen of the display device 30, unlike the rearward images 5, 6, and 7 that slightly parallel movement as the parallel movement processing operation progresses. Thus, the relative positional relationship between the parallel movement auxiliary display line Hs and the rearward images 5, 6, and 7 changes according to the slight parallel movement. Then, as described above, the parallel movement auxiliary display line Hs is set at a y coordinate position (at the vertical center position of y=0) where the x coordinates do not change as a result of the skew processing described later. As a result, the operator may repeatedly press the horizontal movement button 44 until sections of the rearward images 5, 6, and 7 that intersect the horizontal movement auxiliary display line Hs (the left border line 7 and the right border line 5 in this example) are located in symmetrical (equidistant) positions with respect to the centerline ko on the display screen of the display device 30 (refer to FIG. 11 described later). When the left and right border lines 7 and 5 are laid out and displayed on the horizontal movement auxiliary display line Hs so as to be equidistant with respect to the centerline ko, the image position on the horizontal movement auxiliary display line Hs will not change by the subsequent skew processing (since the x coordinates do not change). By performing the horizontal movement processing operation using the horizontal movement auxiliary display line Hs as a guide, the operator can, in other words, determine the optimum horizontal movement amount (horizontal shift) that should be provided to the rearward images 5, 6, and 7.

Note that, rather than repeatedly pressing the horizontal movement button 44 to horizontally move the image by a desired amount of shift as described above, a button for uniquely determining the shift amount and shift direction may be separately provided. Additionally, the form (color, shape, etc.) of a portion of the horizontal movement auxiliary display line Hs may be made to differ from that of the other portion. Additionally, in a case where the horizontal movement processing has substantially ended (in a case where the corresponding sections among the rearward images 5, 6, and 7, i.e., the areas of the left border line 7 and the right border line 5 that intersect the horizontal movement auxiliary display line Hs are positioned equidistant with respect to the centerline ko), the form may be made to differ from the form up to that point in time. Further, in conjunction with completion of this processing, a notification indicating completion (a visual display or audio notification) may be provided.

### (c) Skew Processing

After the above parallel movement processing, skew processing is performed (note that the order may be switched with the parallel movement processing described above). FIG. 11 shows an example of a screen displayed on the display device 30 based on the display image data 49 outputted from the output image creating unit 25 when the operator presses the skew button 46 of the operation switch 40 to perform skew processing after completion of the above-described parallel movement processing. In this example, when the operator presses the skew button 46, the auxiliary line data (skew auxiliary display line data) 48 from the aforementioned OSD creating unit 26 are outputted to the display device 30 via the output image creating unit 25. As a result, a scaled horizontal line as shown in the figure (a dashed line in this example, but a solid line is acceptable as well) is displayed as the skew auxiliary display line Hk. At this time, in this example, this skew auxiliary display line Hk is set and displayed near the bottom edge of the display screen so as to enable more precise adjustment of the wide end section of the rearward images 5, 6, and 7 displayed in an isosceles trapezoidal shape having a wide end. Note that, similar to the above, rather than the skew button 46, a button for displaying the skew auxiliary display line Hk (or a button for transitioning to skew mode) may be separately provided. At this point in time, the skew auxiliary display line Hk and the rearward images 5, 6, and 7 without the skew processing yet performed are displayed on the screen of the display device 30 (refer to FIG. 11). As a result, the operator can clearly visually recognize to what degree the rearward images 5, 6, and 7 should be skewed.

When the operator continues from the above state and presses the skew button 46, θh of the above-described equation (3) of skew processing increases (or decreases) by a predetermined value. As a result, the rearward images 5, 6, and 7 on the display screen are slightly skewed by a predetermined amount (a predetermined number of dots, for example) in a predetermined direction (rightward for the upper half and leftward for the lower half on the display screen of the display device 30 in this example). By repeating this, the operator can perform his/her intended skew processing operation on the rearward images 5, 6, and 7.

Similar to the above, at this time, the skew auxiliary display line k is displayed based on a fixed positional relationship on the display screen of the display device 30, unlike the rearward images 5, 6, and 7 that are slightly skewed as the parallel movement processing operation progresses. Thus, the relative positional relationship between the skew auxiliary display line Hk and the rearward image 5, 6, and 7 changes according to the slight skewing. Then, as described above, the skew auxiliary display line Hk is set at the bottom edge of the display screen of the display device 30 where the changes made to the rearward images 5, 6, and 7 having a wide end shape are easiest to view. As a result, the operator may repeatedly press the skew button 46 until sections of the rearward images 5, 6, and 7 that intersect the skew auxiliary display line Hk (the left border line 7 and the right border line 5 in this example) are located in symmetrical (equidistant) positions with respect to the centerline ko on the display screen of the display device 30 (refer to FIG. 12 described later). When the left and right border lines 7 and 5 are laid out and displayed on the skew auxiliary display line Hk so as to be equidistant with respect to the centerline ko in this manner, the back border line 6 also automatically becomes symmetrically disposed with respect to the centerline ko (the center point of the back border line 6 becomes substantially positioned on the centerline ko). By performing the skew processing operation using the skew auxiliary display line Hk as a guide, the operator can, in other words, determine the optimum amount of skew that should be provided to the rearward images 5, 6, and 7.

Note that, rather than repeatedly pressing the skew button 46 to skew the image by a desired amount of skew as described above, a button for uniquely determining the skew amount and skew direction may be separately provided. Additionally, the form (color, shape, etc.) of a portion of the skew auxiliary display line Hk may be made to differ from that of other portions. Additionally, in a case where the skew processing has substantially ended (in a case where the corresponding sections among the rearward images 5, 6, and 7, i.e., the areas of the left border line 7 and the right border line 5 that intersect the skew auxiliary display line Hk, are positioned equidistant with respect to the centerline ko), the form may be made to differ from the form up to that point in time. Further, in conjunction with completion of this processing, a notification indicating completion (a visual display or audio notification) may be provided.

As described above, while displaying the rearward images 5, 6, and 7 during conversion on the display screen of the display device 30, the operator utilizes the auxiliary display lines Hr, Hs, and Hk on the display screen to perform rotation processing, parallel movement processing, and skew processing until a desired position is achieved. With this arrangement, it is possible for the operator to readily obtain an ideal image.

Note that in a case where, for example, a rearward image is obtained and displayed by the camera 10 provided at the rear of the vehicle 3, there is also a high demand for virtual camera video having a camera optical axis orthogonal to the ground. In such a case, conversion processing that changes the descending vertical angle of the camera 10 (upward viewpoint conversion) is required. In a case where such viewpoint conversion is performed, adjustments can be readily made using auxiliary display lines and methods similar to those of the above-described (A) to (C).

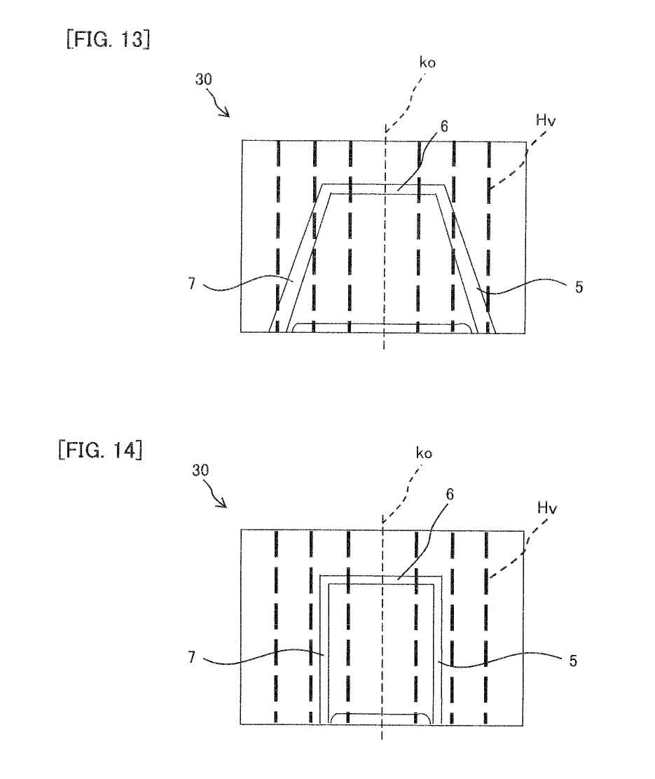

This adjustment can be made by providing a viewpoint conversion button (not shown) similar to the buttons 44, 56, and 46 on the operation switch 40, for example FIG. 13 shows an example of a screen displayed on the display device 30 based on the display image data 49 outputted from the output image creating unit 25 when the operator presses the viewpoint conversion button of the operation switch 40 to perform viewpoint conversion processing after completion of the above-described rotation, parallel movement, and skew processing. In this example, when the operator presses the viewpoint conversion button, the auxiliary line data (viewpoint conversion auxiliary display line data) 48 from the aforementioned OSD creating unit 26 are outputted to the display device 30 via the output image creating unit 25. As a result, a plurality of mutually parallel vertical lines (dashed lines in this example, but solid lines are acceptable as well) is displayed as viewpoint conversion auxiliary display lines Hv as shown is FIG. 13. Note that, similar to the above, rather than the viewpoint conversion button, a button for displaying the viewpoint conversion auxiliary display lines Hv (or a button for transitioning to viewpoint conversion mode) may be separately provided. At this point in time, the viewpoint conversion auxiliary display line Hv and the rearward images 5, 6, and 7 without the viewpoint conversion processing yet performed are displayed on the screen of the display device 30 (refer to FIG. 13). As a result, the operator can clearly visually recognize to what degree the viewpoint conversion processing of rearward images 5, 6, and 7 has been completed.

When the operator continues from the above state and presses the viewpoint conversion button, the viewpoint of the rearward images 5, 6, and 7 on the display screen moves slightly upward (changing the vertical descending angle) by a predetermined amount (conversion of the actual distance in the vertical direction is also possible) in a predetermined direction (so that the viewpoint of the camera 10 rises further upward from the normal installation position reference in this example). Accordingly, even though the left border line 7 and the right border line 5 constitute a shape with a wide end as described above, the wideness of the rearward images 5, 6, and 7 decreases. By repeating this operation, the operator can eventually perform his/her intended viewpoint conversion processing operation (changing the viewpoint to a downward viewpoint where the camera optical axis is orthogonal to the ground, for example) on the rearward images 5, 6, and 7.

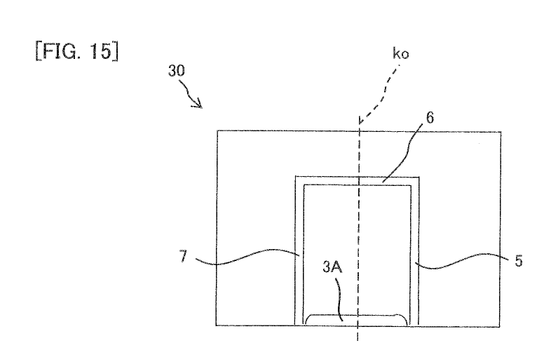

Similar to the above, at this time, the viewpoint conversion auxiliary display lines Hv are displayed based on a fixed positional relationship on the display screen of the display device 30, unlike the rearward images 5, 6, and 7 that slightly change shape as the viewpoint conversion processing operation progresses. Thus, the relative positional relationship between the viewpoint conversion auxiliary display lines Hv and the rearward images 5, 6, and 7 changes according to the slight shape change described above. Then, as previously described, viewpoint conversion processing eventually converts the viewpoint to a downward viewpoint so that the camera optical axis is perpendicular to the ground. In this state, the left border line 7 and the right border line 5 are both set in the vertical direction on the display screen, in mutually parallel positions. Thus, the operator simply repeatedly presses the viewpoint conversion button until the left border line 7 and the right border line 5 of the rearward images 5, 6 and 7 are substantially parallel with the viewpoint conversion auxiliary display lines Hv. When the left and right border lines 7 and 5 are parallel to the viewpoint conversion auxiliary display lines Hv (refer to FIG. 14), the left and right border lines 7 and 5 automatically become perpendicular to the back border line 6, substantially forming a square shape that is open to the left (downward viewpoint) (refer to FIG. 15). By performing the viewpoint conversion processing operation using the rotation viewpoint conversion auxiliary display lines Hv as a guide, the operator can, in other words, determine the optimum amount of shape change that should be provided to the rearward images 5, 6, and 7.

Note that, rather than repeatedly pressing the viewpoint conversion button to raise the viewpoint by a predetermined distance as described above, a button for uniquely determining the viewpoint movement amount and movement direction may be separately provided. Additionally, the form (color, shape, etc.) of a portion of the viewpoint conversion auxiliary display lines Hv, for example, may be made to differ from that of the others. Also, in a case where the viewpoint conversion processing has substantially ended (in a case where corresponding, sections among the rearward images 5, 6, and 7, such as the left border line 7 and the right border line 5, are substantially parallel to the viewpoint conversion auxiliary display lines Hv), the form may be made to differ from the form up to that time. Further, in conjunction with completion of this processing, a notification indicating completion (a visual display or audio notification) may be provided.

As described above, the conversion processing using the viewpoint conversion auxiliary display lines Hv, which constitute a plurality of mutually parallel vertical lines, makes it possible for the operator to reliably check that the left border line 7 and the right border line 5 separated by a distance to the left and to the right appear vertical (i.e., mutually parallel) on the display screen, which is otherwise difficult to do.

The vehicular image processing device 20 of the above embodiment comprises the image acquiring unit 21 (image acquiring unit) configured to acquire peripheral image data based on the peripheral image of the vehicle 3 from the imaging unit 10 (camera) configured to take an image of the periphery of the vehicle 3, the image converting unit 23 (image converting unit) configured to perform conversion processing on the peripheral image data 9 acquired by the image acquiring unit 21 and generate the converted image data 27, the instruction signal inputting unit 28 (input control unit) configured to input the instruction signal 43 for providing instructions regarding the conversion processing mode to be achieved by the image converting unit 23, the auxiliary display line generating unit 26 (OSD creating unit) configured to generate the auxiliary display line data 48 used to perform auxiliary display on the display unit 30 (display device) for providing instructions regarding the conversion processing mode, and the image outputting unit 25 (output image creating unit) configured to output the display image data 49 generated based on the converted image data 27 and the auxiliary display line data 48.

In the vehicular image processing device 20, the image acquiring unit 21 acquires the peripheral image data 9 from the imaging unit 10 configured to take images of the periphery of the vehicle 3. In the image converting unit 23, conversion processing is performed on the acquired peripheral image data 9 using a conversion processing mode that is based on the instruction signal 43 inputted by the instruction signal inputting unit 28 so as to generate the converted image data 27. With this arrangement, the conversion processing mode is inputted based on an operation by the operator in accordance with the installation position of the imaging unit 10 with respect to the vehicle 3, thereby performing conversion processing on the peripheral image data 9 in accordance with the instruction signal 43 and displaying the converted peripheral image on the display unit 30.

At this time, the auxiliary display line data 48 generated by the auxiliary display line generating unit 26 are outputted to the display unit 30 as the display image data 49 in combination with the converted image data 27, thereby making it possible for the operator (the driver, for example) to display the converted peripheral image and the auxiliary display lines Hr, Hs, Hk, and Hv superimposed on the display unit 30 during the above operation, and visually check the image. As a result, the operator can easily adjust the degree and content of the conversion processing while comparing the displayed peripheral image during conversion processing with the auxiliary display lines Hr, Hs, Hk, and Hv (used as guides) so as to form a desired image. Thus, it is possible to reliably display a peripheral image subjected to desired conversion processing on the display unit 30 regardless of the installation location of the imaging unit 10, and provide an appropriate peripheral image to the operator. As a result, it is possible to significantly improve the tolerance of the installation location of the imaging unit 10.

The vehicular image processing device 20 of the above embodiment, in addition to the above configuration, features the auxiliary display line generating unit 26 that generates the auxiliary display line data 48 of a plurality of types in accordance with the conversion processing mode instructed by the instruction signal 43.

With this arrangement, during the conversion processing executed by the operator using the image converting unit 23 in order to obtain a peripheral image of a desired form, it is possible to display the auxiliary display lines Hr, Hs, Hk, and Hv on the display unit 30 so as to ensure the utmost convenience (easy adjustability).

The vehicular image processing device 20 of the aforementioned embodiment, in addition to the above configuration, features the image converting unit 23 that performs at least one type of conversion processing among rotation, skew, and parallel movement processing on the peripheral image data 9 so as to generate the converted image data 27.

With this arrangement, even in a case where the imaging unit 10 is disposed in away from the substantial center position of the vehicle width direction (skew and parallel movement processing), and even in a case where the imaging unit 10 is disposed on an incline with respect to the vehicle horizontal direction (rotation processing), it is possible to perform the corresponding conversion (correction) of the peripheral image and display a peripheral image of a desired form on the display unit 30.

The vehicular image processing device 20 of the aforementioned embodiment, in addition to the above configuration, features the auxiliary display line generating unit 26 that generates the auxiliary display line data 48 for displaying as an auxiliary display at least the plurality of mutually parallel horizontal lines Hr (rotation auxiliary display lines), the scaled horizontal lines Hs (parallel movement auxiliary display line) and Hk (skew auxiliary display line), or the plurality of mutually parallel vertical lines Hv (viewpoint conversion auxiliary display lines) on the display unit 30.

With this arrangement, the operator can easily set the amount of rotation in a case where rotation is performed as conversion processing, the amount of skew and movement in a case where skewing and parallel movement are performed, and the size of the descending vertical angle when descending vertical angle correction is performed.

The vehicular image processing device 20 of the aforementioned embodiment, in addition to the above configuration, features the image converting unit 23 that performs at least skewing or parallel movement as the conversion processing on the peripheral image data 9 after rotation is performed.

The act of performing rotation processing, which results in displacement in the vertical direction (y direction) of the image on the display unit 30, followed by skew or parallel movement processing, which does not result in displacement in the vertical direction, makes it possible to improve adjustment operability, enabling the operator to perform easy adjustments.

The vehicular image processing device 20 of the aforementioned embodiment, in addition to the above configuration, features the auxiliary display line generating unit 26 that generates the auxiliary display line data 48 so as to display the scaled horizontal lines Hs and Hk after to display the plurality of mutually parallel horizontal lines Hr, as auxiliary displays.

The act of performing rotation processing, which results in displacement of the image in the vertical direction (y direction) on the display unit 30, followed by the skew or parallel movement processing, which does not result in displacement in the vertical direction, in combination with the corresponding display of the plurality of parallel horizontal lines Hr for rotation and the scaled horizontal line Hs and Hk for skewing and parallel movement, makes it possible to easily set the amount of adjustment for each of the above adjustments and further improve adjustment operability.

1-8. (canceled)

9. A vehicular image processing device comprising:
an image acquiring unit configured to acquire peripheral image data based on a peripheral image of a vehicle using an imaging unit configured to take images of the periphery of said vehicle;
an image converting unit configured to perform conversion processing on said peripheral image data acquired by said image acquiring unit and generate converted image data;
an instruction signal inputting unit configured to input an instruction signal for providing instructions regarding a conversion processing mode to be achieved by said image converting unit;
an auxiliary display line generating unit configured to generate auxiliary display line data for an auxiliary display on a display unit for providing instructions for said conversion processing mode; and
an image outputting unit configured to output display image data generated based on said converted image data and said auxiliary display line data, wherein:
said auxiliary display line generating unit generates said auxiliary display line data so as to display a scaled horizontal line after to display a plurality of mutually parallel horizontal lines, as said auxiliary display in accordance with the conversion processing mode instructed by said instruction signal, and
said image converting unit performs as said conversion processing rotation processing on said peripheral image data so as to generate said converted image data when said auxiliary display line generating unit generates said auxiliary display line data so as to display as said auxiliary display a plurality of mutually parallel horizontal lines, and
subsequently said image converting unit performs as said conversion processing parallel movement processing on said peripheral image data so as to generate said converted image data when said auxiliary display line generating unit generates said auxiliary display line data so as to display as said auxiliary display said scaled horizontal line; and further
subsequently said image converting unit performs as said conversion processing skew processing on said peripheral image data so as to generate said converted image data when said auxiliary display line generating unit generates said auxiliary display line data so as to display as said auxiliary display said scaled horizontal line.

10. The vehicular image processing device according to claim 9, wherein:
said auxiliary display line generating unit generates said auxiliary display line data so as to display said scaled horizontal line at one axial side coordinate position among orthogonal coordinates on said display unit that does not result in a change in the other axial side coordinates even if said image converting unit performs as said conversion processing said skew processing on said peripheral image data when said auxiliary display line data are generated so as to display as said auxiliary display said scaled horizontal line when said image converting unit performs as said conversion processing said parallel movement processing on said peripheral image data.

11. The vehicular image processing device according to claim 9, wherein:
said image converting unit performs as said conversion processing said skew processing on said peripheral image data so as to generate said converted image data; and subsequently
said image converting unit performs on said peripheral image data as said conversion processing viewpoint conversion processing for converting the viewpoint to a downward viewpoint so that an optical axis of said imaging unit becomes orthogonal to the ground, thereby generating said converted image data, when said auxiliary display line generating unit generates said auxiliary display line data so as to display as said auxiliary display a plurality of mutually parallel vertical lines.

12. The vehicular image processing device according to claim 9, wherein:
said instruction signal inputting unit inputs said instruction signal generated by an operation to an operation unit.

13. A vehicular image processing program which is executed by a computer, comprising the steps of:
a step for acquiring peripheral image data based on a captured peripheral image of a vehicle;
a step for inputting an instruction signal for providing instructions regarding a conversion processing mode of said conversion processing to the peripheral image data acquired;
a step for performing rotation processing on the peripheral image data acquired as conversion processing and generating converted image data as well as generating auxiliary display line data so as to display a plurality of mutually parallel horizontal lines as said auxiliary display in accordance with the conversion processing mode instructed by said instruction signal;
a step for performing parallel movement processing on the peripheral image data acquired as conversion processing and generating converted image data as well as generating auxiliary display line data so as to display a scaled horizontal lines as said auxiliary display in accordance with the conversion processing mode instructed by said instruction signal, after the step for performing rotation processing;
a step for performing skew processing on the peripheral image data acquired as conversion processing and generating converted image data as well as generating auxiliary display line data so as to display said scaled horizontal lines as said auxiliary display in accordance with the conversion processing mode instructed by said instruction signal, after the step for performing parallel processing; and
a step for outputting display image data generated based on said converted image data and said auxiliary display line data.
